(19) United States
(12) Patent Application Publication
(10) Pub. No.: US 2016/0124139 A1
(43) Pub. Date: May 5, 2016

(54) REFLECTIVE TRAY FOR A BACKLIGHT, COMPRISING A POLYMERIC DIELECTRIC MULTILAYER REFLECTOR

(71) Applicant: 3M INNOVATIVE PROPERTIES COMPANY, Saint Paul, MN (US)

(72) Inventors: Jiro Hattori, Kanagawa Perf. (JP); Mio Kugue, Kanagawa Perf. (JP); Yuji Saito, Kanagawa Perf. (JP); Brian A. Kinder, Woodbury, MN (US); Gary T. Boyd, Woodbury, MN (US); James W. Laumer, White Bear Lake, MN (US)

(73) Assignee: 3M INNOVATIVE PROPERTIES COMPANY, St. Paul, MN (US)

(21) Appl. No.: 14/892,256

(22) PCT Filed: May 27, 2014
(86) PCT No.: PCT/US2014/039524

§ 371 Date: Nov. 19, 2015

Related U.S. Application Data
(60) Provisional application No. 61/829,494, filed on May 31, 2013.

(51) Int. Cl. F21V 8/00; G02B 5/08

(52) U.S. Cl. CPC G02B 6/0055; G02B 5/0841; G02B 6/0093; G02B 6/0085; G02B 6/0065

(57) ABSTRACT

The present disclosure relates to reflective trays (101) comprising a polymeric dielectric multilayer reflector material, backlight modules incorporating said reflective trays, articles using said backlight modules, and methods of making said reflective trays useful for backlight modules. In particular, the backlight modules have a reduced tendency to leak light into unwanted areas, and also form a compact unit having a narrow bezel, that at least partially surrounds the components of the backlight and/or the display.

### BACKGROUND

Electronic devices, in particular hand-held electronic devices having a liquid crystal display

(LCD), utilize backlights having optimized arrangements of light management films, reflectors, and light guides to efficiently distribute the light generated by advanced light sources such as light emitting diodes (LEDs). It can be desirable to ensure that light from the backlight is not leaked to areas that are not intended to be illuminated, while still maintaining a compact size and a narrow bezel.

### SUMMARY

The present disclosure relates to reflective trays, backlight modules incorporating reflective trays, articles using the backlight modules, and methods of making the reflective trays useful for backlight modules. In particular, the backlight modules have a reduced tendency to leak light into unwanted areas, and also form a compact unit having a narrow bezel, that at least partially surrounds the components of the backlight and/or the display. In one aspect, the present disclosure provides an article that includes a reflective tray having sides, a bottom, and an open top, the reflective tray configured to at least partially enclose: a light guide; a light source optically coupled to the light guide; and at least one light management film immediately adjacent the open top, wherein the reflective tray includes a polymeric dielectric multilayer reflector.

In another aspect, the present disclosure provides an article that includes a reflective tray having sides, a bottom, and an open top; a light guide and a light source optically coupled to the light guide, disposed between the bottom and the open top; and at least one light management film immediately adjacent the open top, wherein the reflective tray includes a polymeric dielectric multilayer reflector.

In another aspect, the present disclosure provides a method that includes scoring a polymeric dielectric multilayer reflector along a bottom perimeter of a reflective tray bottom, the reflective tray bottom having corners; removing portions of the polymeric dielectric multilayer reflector exterior to the reflective tray bottom and adjacent the corners; and folding the polymeric dielectric multilayer reflector along the bottom perimeter to form a reflective tray having sides extending perpendicular to the reflective tray bottom, and an open top.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1A shows a perspective schematic view of a foldable template;

FIG. 1B shows a perspective schematic view of a reflective tray formed from the foldable template of FIG. 1A;

FIG. 2A shows a perspective schematic view of a backlight article;

FIG. 2B shows an exploded cross-sectional schematic view of a backlight module;

FIG. 2C-2H show a cross-sectional schematic view of a backlight module;

FIG. 3 shows a perspective schematic view of a backlight module;

FIG. 4A shows a perspective schematic view of a foldable template; and

FIG. 4B shows a perspective schematic view of a reflective tray formed from the foldable template of FIG. 4A.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure relates to reflective trays, backlight modules incorporating reflective trays, articles using the backlight modules, and methods of making the reflective trays useful for backlight modules. In particular, the backlight modules have a reduced tendency to leak light into unwanted areas, and also form a compact unit having a narrow bezel, that at least partially surrounds the components of the backlight and/or the display.

In one particular embodiment, the present disclosure provides a template that can be cut from a reflector and folded to form a reflective tray that encloses a light source, a light guide, and one or more light management films. The reflective tray has an open top surface that is placed adjacent an LCD panel and either partially surrounds the LCD or is adhered to a surface of the LCD such that light passes through the LCD and is prevented from leaking from around the light source, light guide, or light management films.

The reflector can be any suitable reflector including diffuse reflectors, specular reflectors, semi-specular reflectors, and the like. The reflector can be made from a variety of materials including metals or metal alloys, metal or metal alloy coated polymers, organic or inorganic dielectric multilayer reflectors, or a combination thereof. In one particular embodiment, the reflector is preferably a polymeric dielectric multilayer reflector, such as Vikuiti™ ESR (enhanced specular reflector) available from 3M Company. The light management films typically comprise one or more reflective polarizer films, diffuser films, microstructured brightness enhancing films, or a combination thereof, as known to one of skill in the art.

In the following description, reference is made to the accompanying drawings that forms a part hereof and in which are shown by way of illustration. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

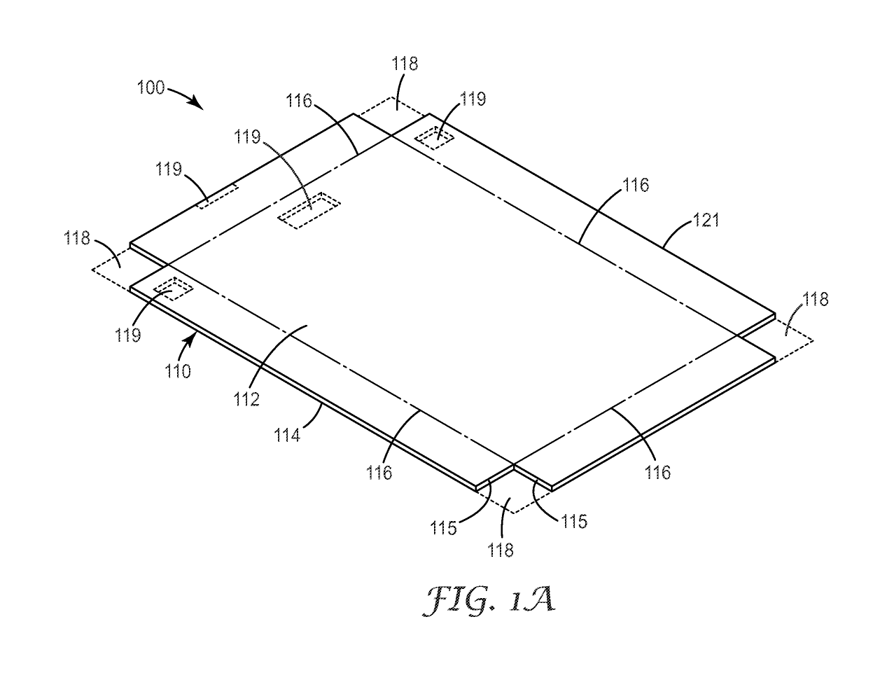

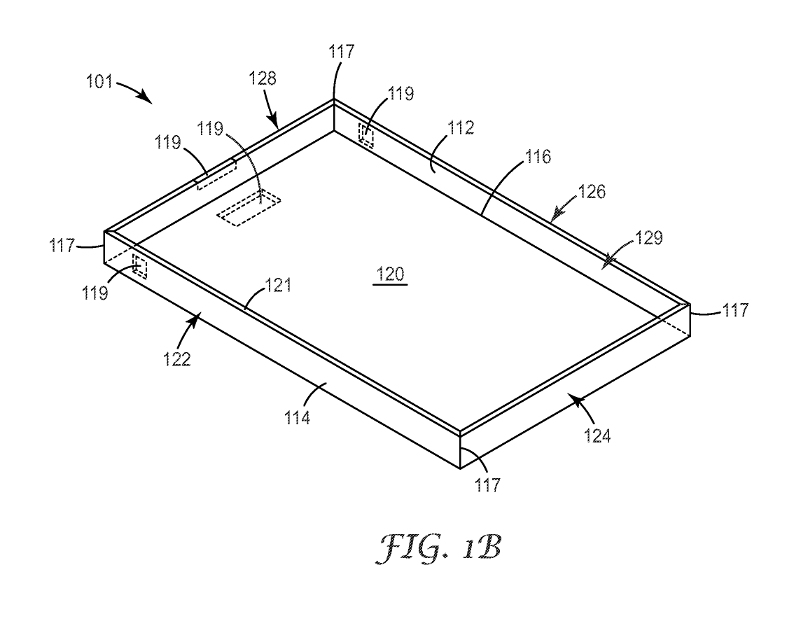

FIG. 1A shows a perspective schematic view of a foldable template 100 that can be used to form a reflective tray, according to one aspect of the disclosure. Foldable template 100 is made from a reflective sheet 110 that includes a first major surface 112, an opposing second major surface 114, and a perimeter 121. Exterior portions 118 are removed from the corners of the reflective sheet 110 to form edges 115, and optional openings 119 are cut through the thickness dimension of the reflective sheet. The exterior portions 118 and optional openings 119 can be removed using any suitable technique including, for example, knife cutting, die cutting, punching, laser cutting, and the like. A score line 116 that is generally parallel to and separated from the perimeter 121 partially penetrates the thickness dimension of the reflective sheet 110, such that the reflective sheet 110 can be easily folded to form a reflective tray having sides and a bottom, as described elsewhere. Scoring can be done to make any desired number of sides for the reflective tray, which can have 1, 2, 3, 4, or more sides as desired. The score line 116 can be made using any suitable technique including, for example, thermal or mechanical embossing, die cutting, kiss cutting, laser scoring, and the like. Laser scoring can be a preferred method of forming score line 116, as described elsewhere.

FIG. 1B shows a perspective schematic view of a reflective tray 101 formed from the foldable template 100 of FIG. 1A, according to one aspect of the disclosure. Reflective tray 101 is formed by folding up each of the portions between the score line 116 and perimeter 121 so that each of the edges 115 meet to form a corner 117. Reflective tray 101 includes a bottom 120, a first through fourth sides 122, 124, 126, and 128, an open top 129, and interior surface 112 and exterior surface 114. Optional openings 119 are positioned in any or all of the bottom 120 and sides 122, 124, 126, 128 as desired, for external attachment of components within the reflective tray 101, for through-passage of electrical lines from the exterior to the interior of the tray, for passage of light from an exterior light source to the interior of the tray, and the like, as described elsewhere.

In one particular embodiment, corners 117 may include an adhesive layer (not shown) or an adhesive tape (not shown) to bond the respective sides together. In some cases, corners 117 may be bonded together by other techniques including thermal bolding, ultrasonic welding, laser welding, or mechanical methods including slot/tab techniques and the like, as known to one of skill in the art. In some cases, reflective tray 101 can instead be thermoformed from reflective sheet 110, such as a Vikuiti™ ESR film, and the score lines 116 may be optional. In some cases, the corners 117 in a thermoformed reflective tray 101 may be part of a contiguous film. In some cases, the thermoformed reflective tray 101 can be subsequently removed from the remaining reflective sheet 110 after forming by, for example, laser cutting, knife cutting, or die cutting. In some cases, reflective tray 101 can instead be thermoformed from reflective sheet 110 after the exterior portions 118 have been removed, and the corners 117 bonded together as described above. Thermoforming of polymeric films such as ESR films are known to those of skill in the art.

A variety of layers can be applied to any desired portion of the interior surface 112 and/or the exterior surface 114, as desired. These layers are optional, and can include coatings, films, and sheets that are deposited, adhered, laminated, or otherwise affixed to the respective surface. In one particular embodiment, the layer applied to the exterior surface 114 can be, for example, a thermally conductive layer, an optically absorptive layer, a structural supporting layer, a combination thereof, and the like. In some cases, a thermally conductive exterior layer having, for example, thermally conductive particles in a binder, or metallic films or sheets, can be useful for aiding extraction of heat from a light source (not shown) that is placed within the reflective tray 101, as described elsewhere. In one particular embodiment, the layer applied to the interior surface 112 can be a diffuse layer, an optically absorptive layer, or a combination thereof. In some cases, a diffuse layer can be preferably applied to the interior surface 112 of one or more of the sides 122, 124, 126, 128, or the bottom 120, of the reflective tray 101.

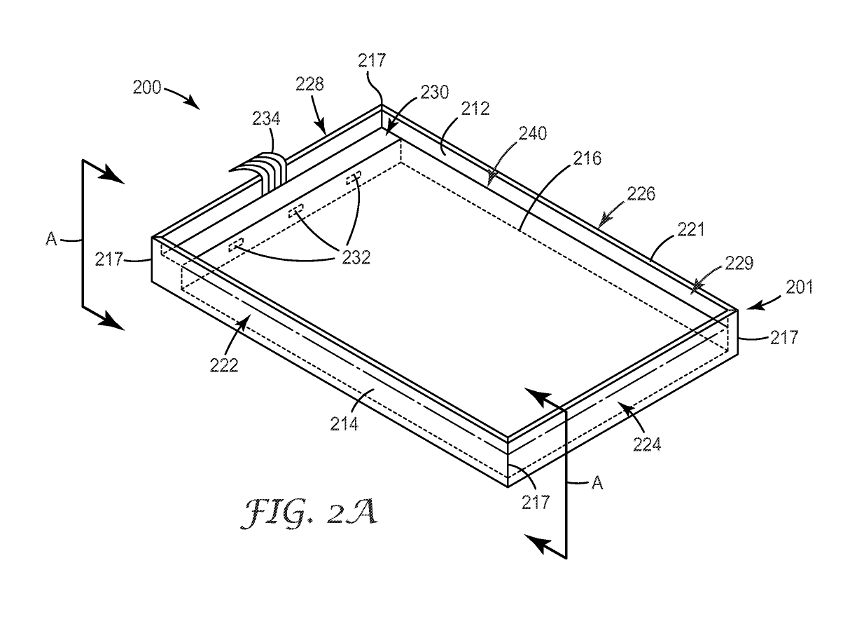

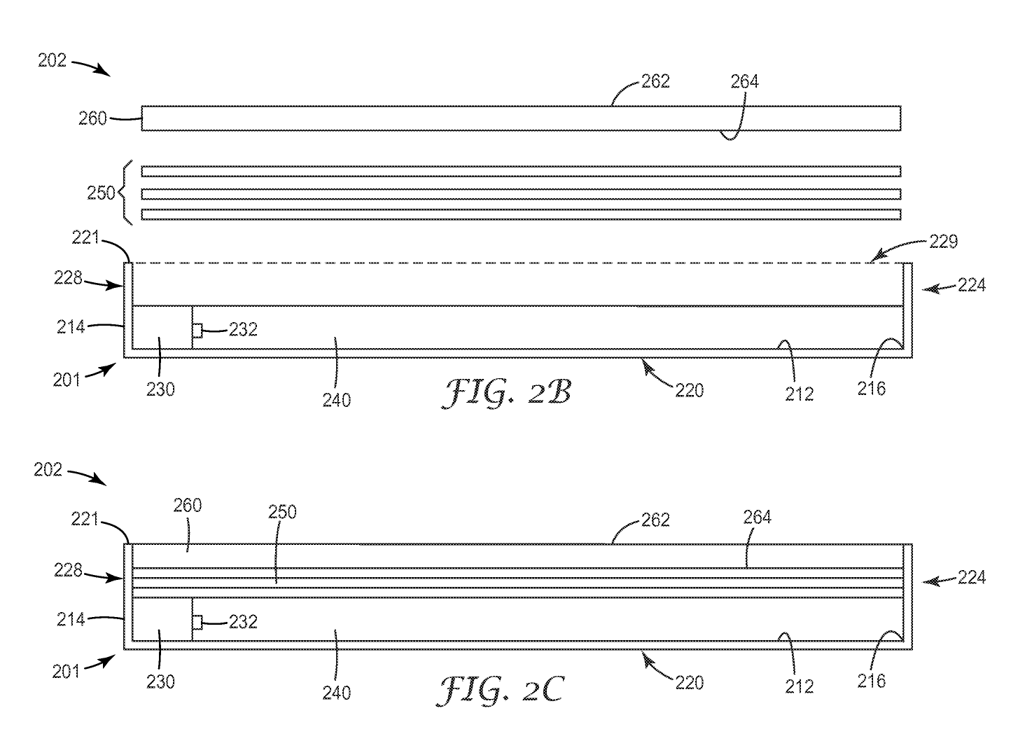

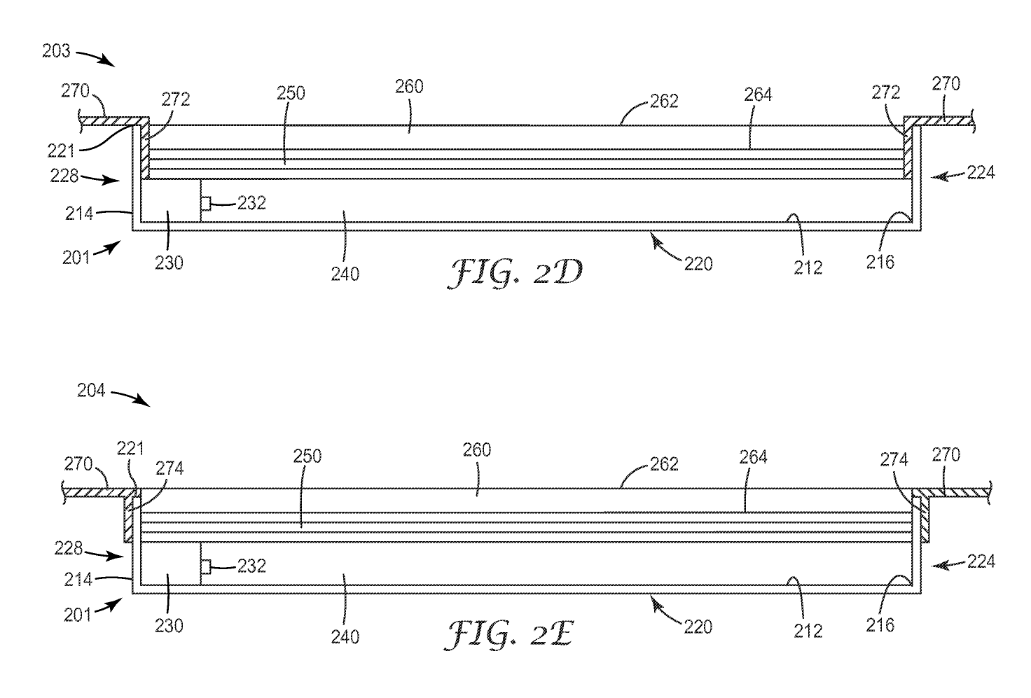

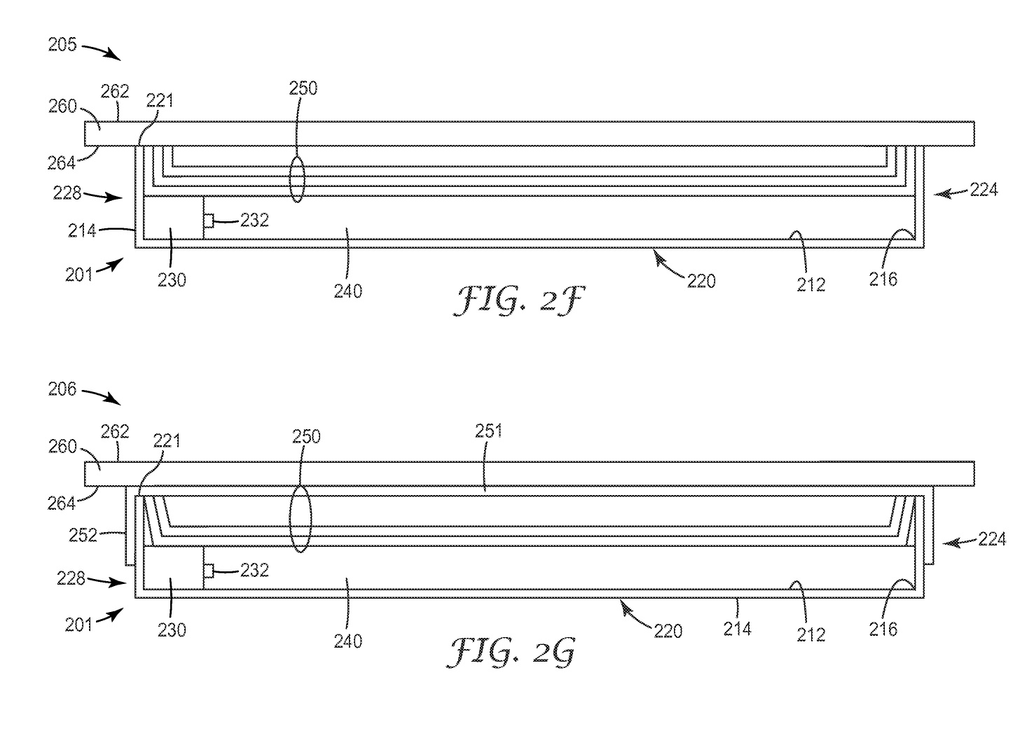

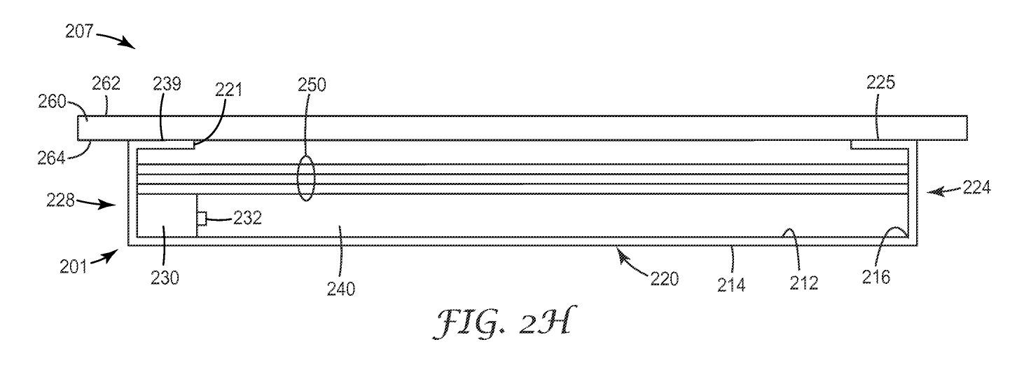

FIG. 2A shows a perspective schematic view of a backlight article 200, according to one aspect of the disclosure. Each of the elements 201-229 shown in FIG. 2A correspond to like-numbered elements 101-129 shown in FIG. 1B, which have been described previously. For example, corner 217 in FIG. 2A corresponds to corner 117 in FIG. 1B, and so on. Backlight article 200 includes a reflective tray 201 having sides 222, 224, 226, 228, bottom 220, interior surface 212, exterior surface 214, score line 216, and perimeter 221. Reflective tray 201 houses a light source 230 disposed adjacent side 228, one or more lights 232 (e.g., LEDs or other light sources as known in the art), and an electrical connection 234 that extends to the exterior of reflective tray 201. The electrical connection 234 either passes through optional openings (not shown, described elsewhere) or over the perimeter 221. A light guide 240, such as a light guide plate is optically coupled to the light source 230 and placed within reflective tray 201 of the backlight article 200, and bounded by the sides 222, 224, 226, 228. Light guide 240 and light source 230 may include portions that pass through optional openings (not shown, described elsewhere) for other connections or structural support. In some cases, portions of light source 230 may be located externally to the reflective tray 201, and light can pass through the optional openings.

FIG. 2B shows an exploded cross-sectional schematic view of backlight module 202 through section A-A′ of backlight article 200 of FIG. 2A, according to one aspect of the disclosure. Each of the elements 201-240 shown in FIG. 2B correspond to like-numbered elements 201-240 shown in FIG. 2A, which have been described previously. Backlight module 202 includes a reflective tray 201 having sides 224, 228, bottom 220, interior surface 212, exterior surface 214, score line 216, a light source 230 having at least one light 232, and light guide 240 optically coupled to light source 230. A light management film stack 250 having at least one light management film is disposed to be place within reflective tray 201, through top opening 229. An LCD panel 260 having a top surface 262 and an opposing bottom surface 264, is positioned adjacent the light management film stack 250.

FIG. 2C shows a cross-sectional schematic view of a backlight module 202 including an LCD panel 260, according to one aspect of the disclosure. Each of the elements 201-264 shown in FIG. 2C correspond to like-numbered elements 201-264 shown in FIG. 2B, which have been described previously. Backlight module 202 includes a reflective tray 201 having sides 224, 228, bottom 220, interior surface 212, exterior surface 214, score line 216, a light source 230 having at least one light 232, and light guide 240 optically coupled to light source 230. A light management film stack 250 having at least one light management film is disposed within reflective tray 201, and an LCD panel 260 having a top surface 262 and an opposing bottom surface 264 is positioned adjacent the light management film stack 250.

In one particular embodiment, the LCD panel 260 can fit within reflective tray 201, as shown in FIG. 2C, and each of the sides 224, 228, can be affixed to one or more of the LCD panel 260, the light management film stack 250, the light source 230, and the light guide 240, by an adhesive layer (not shown). In some cases, the top surface 262 of the LCD panel 260 can be at the same level with the perimeter 221 of reflective tray 201, as shown in FIG. 2C. In some cases, the top surface 262 of the LCD panel 260 can be positioned either above or below the perimeter 221 of reflective tray 201.

In one particular embodiment, the LCD panel 260 can be larger than the reflective tray 201, and the perimeter 221 of reflective tray 201 can be positioned adjacent bottom surface 264 of LCD panel 260 (not shown), as described elsewhere. In some cases, an adhesive layer (also not shown) can attach the perimeter 221 of the reflective tray 201 to the bottom surface 264 of LCD panel 260.

FIG. 2D shows a cross-sectional schematic view of a backlight module 203 including an LCD panel 260, according to one aspect of the disclosure. Each of the elements 201-264 shown in FIG. 2D correspond to like-numbered elements 201-264 shown in FIG. 2C, which have been described previously. Backlight module 203 includes a reflective tray 201 having sides 224, 228, bottom 220, interior surface 212, exterior surface 214, score line 216, a light source 230 having at least one light 232, and light guide 240 optically coupled to light source 230. A light management film stack 250 having at least one light management film is disposed within reflective tray 201, and an LCD panel 260 having a top surface 262 and an opposing bottom surface 264 is positioned adjacent the light management film stack 250. A frame 270 having a flange 272 is positioned around the LCD panel 260, adjacent the interior surface 212 of the sides 224, 228. It is to be understood that the flange 272 also can also extend adjacent the interior surface 212 of the sides 222, 226 shown in FIG. 2A. The flange 272 provides for support of the components in the backlight module 203, and each of the components can be affixed to the flange 272 by, for example, adhesives or mechanical means. In some cases, the flange 272 can extend for any distance from the perimeter 221 toward the bottom 220, and can even extend to contact the bottom 220. The other components (i.e., light source 230, light guide 240, light management film stack 250 and LCD panel 260) within reflective tray 201 are sized accordingly to accommodate the flange 272.

FIG. 2E shows a cross-sectional schematic view of a backlight module 204 including an LCD panel 260, according to one aspect of the disclosure. Each of the elements 201-264 shown in FIG. 2E correspond to like-numbered elements 201-264 shown in FIG. 2D, which have been described previously. Backlight module 204 includes a reflective tray 201 having sides 224, 228, bottom 220, interior surface 212, exterior surface 214, score line 216, a light source 230 having at least one light 232, and light guide 240 optically coupled to light source 230. A light management film stack 250 having at least one light management film is disposed within reflective tray 201, and an LCD panel 260 having a top surface 262 and an opposing bottom surface 264 is positioned adjacent the light management film stack 250. A frame 270 having a flange 274 is positioned around the reflective tray 201, adjacent the exterior surface 214 of the sides 224, 228. It is to be understood that the flange 274 also can also extend adjacent the exterior surface 214 of the sides 222, 226 shown in FIG. 2A. The flange 274 provides for support of the components in the backlight module 203, and the exterior surface 214 can be affixed to the flange 274 by, for example, adhesives or mechanical means. In some cases, the flange 274 can extend for any distance from the perimeter 221 toward the bottom 220, and can even extend beyond the bottom 220.

In one particular embodiment, the positions of flange 272 in backlight module 203 shown in FIG. 2D and flange 274 in backlight module 204 shown in FIG. 2E, can be combined such that at least one of the sides 222, 224, 226, 228 can be partially encased (not shown) within the respective flange; i.e., both the interior surface 212 and exterior surface 214 of the partially encased side is in contact with the flange.

FIG. 2F shows a cross-sectional schematic view of a backlight module 205 including an LCD panel 260, according to one aspect of the disclosure. Each of the elements 201-264 shown in FIG. 2F correspond to like-numbered elements 201-264 shown in FIG. 2C, which have been described previously. Backlight module 205 includes a reflective tray 201 having sides 224, 228, bottom 220, interior surface 212, exterior surface 214, score line 216, a light source 230 having at least one light 232, and light guide 240 optically coupled to light source 230. A light management film stack 250 having at least one light management film is scored and folded in a manner similar to the template shown in FIG. 1A, and disposed within reflective tray 201, and an LCD panel 260 having a top surface 262 and an opposing bottom surface 264 is positioned adjacent the light management film stack 250. The LCD panel 260 can be larger than the reflective tray 201, and the perimeter 221 of reflective tray 201 can be positioned adjacent bottom surface 264 of LCD panel 260. In some cases, an adhesive layer (not shown) can attach the perimeter 221 of the reflective tray 201 to the bottom surface 264 of LCD panel 260.

FIG. 2G shows a cross-sectional schematic view of a backlight module 206 including an LCD panel 260, according to one aspect of the disclosure. Each of the elements 201-264 shown in FIG. 2G correspond to like-numbered elements 201-264 shown in FIG. 2C, which have been described previously. Backlight module 205 includes a reflective tray 201 having sides 224, 228, bottom 220, interior surface 212, exterior surface 214, score line 216, a light source 230 having at least one light 232, and light guide 240 optically coupled to light source 230. A first portion of light management film stack 250 having at least one light management film is scored and folded in a manner similar to the template shown in FIG. 1A, and disposed within reflective tray 201.

A second portion of the light management film stack 250 (e.g., a topmost film 251, scored and folded in a manner similar to the template shown in FIG. 1A) extends across the top opening 229 and can extend as flaps 252 disposed adjacent the exterior surface 214 of sides 224, 228 (and also sides 222, 226 not shown in this view, as described elsewhere). In some cases, the second portion of the light management film stack 250 (e.g., topmost film 251, scored and folded in a manner similar to the template shown in FIG. 1A) can extend across the top opening 229 and can extend as flaps 252 disposed adjacent the interior surface 212 (not shown) of sides 224, 228 (and also sides 222, 226 not shown in this view, as described elsewhere). The flaps 252 can be adhered to the exterior surface 214 (or alternately the interior surface 212) using, for example, an adhesive, thereby forming a sealed reflective tray 201. In some cases, a combination of attachment of one or more of the sides 222, 224, 226, 228, to either the interior surface 212 or the exterior surface 214 can be used. An LCD panel 260 having a top surface 262 and an opposing bottom surface 264 can be positioned adjacent the topmost film 251 of the light management film stack 250.

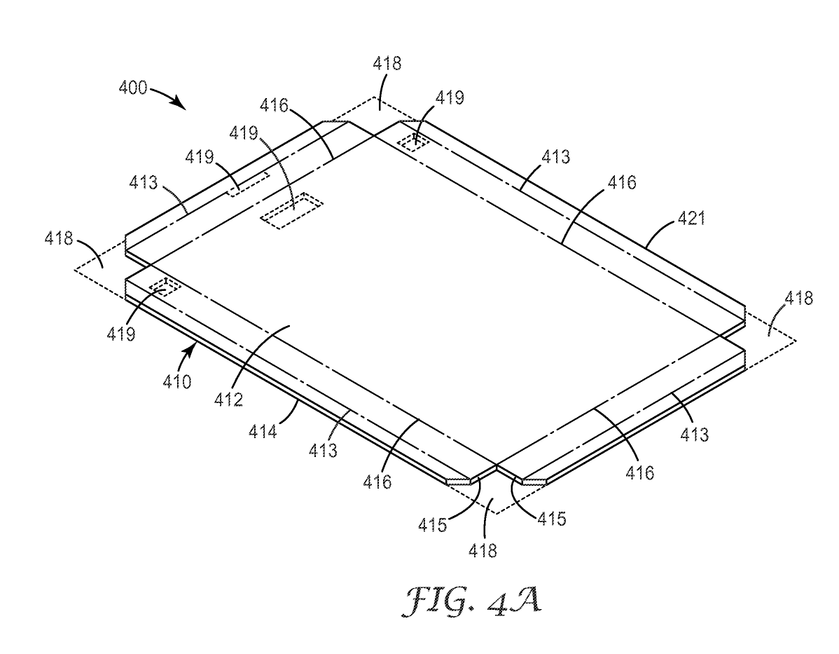

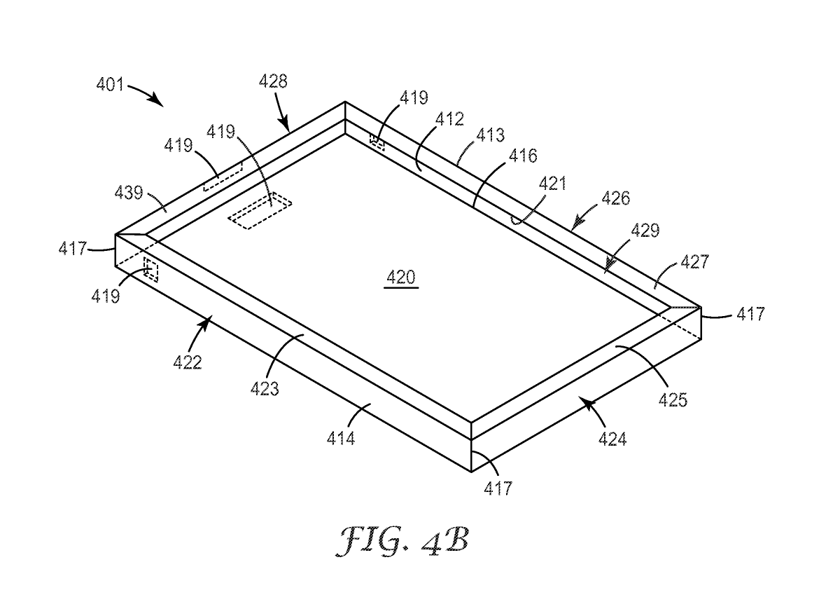

FIG. 2H shows a cross-sectional schematic view of a backlight module 207 including an LCD panel 260, according to one aspect of the disclosure. Each of the elements 201-264 shown in FIG. 2H correspond to like-numbered elements 201-264 shown in FIG. 2C, which have been described previously. Backlight module 207 includes a reflective tray 201 having sides 224, 228, bottom 220, interior surface 212, exterior surface 214, score line 216, a light source 230 having at least one light 232, and light guide 240 optically coupled to light source 230. A light management film stack 250 having at least one light management film is disposed within reflective tray 201. Reflective tray 201 includes a rim 225, 239, that extends over a portion of the top 229, as described elsewhere with reference to FIGS. 4A-4B. An LCD panel 260 having a top surface 262 and an opposing bottom surface 264 is positioned adjacent the light management film stack 250. The LCD panel 260 can be larger than the reflective tray 201, and the rim 225, 239 of reflective tray 201 can be positioned adjacent bottom surface 264 of LCD panel 260. In some cases, an adhesive layer (not shown) can attach the rim 225, 239 of the reflective tray 201 to the bottom surface 264 of LCD panel 260. In some cases, a topmost film (similar to that shown in FIG. 2G) of the light management film stack 250 can be disposed adjacent the rim 225, 239 and adhered to it, thereby forming a sealed reflective tray 201 which can be positioned adjacent the bottom surface 264 of the LCD panel 260.

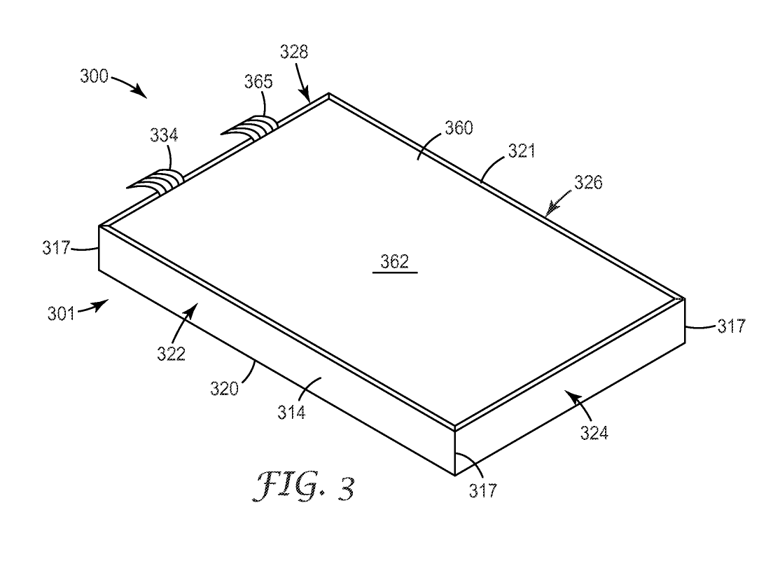

FIG. 3 shows a perspective schematic view of a backlight module 300 including an LCD panel 360, according to one aspect of the disclosure. Each of the elements 301-362 shown in FIG. 3 correspond to like-numbered elements 201-262 shown in FIG. 2C, which have been described previously.

For example, corner 317 in FIG. 3 corresponds to corner 217 in FIG. 2C, and so on. Backlight module 300 includes a reflective tray 301 having sides 322, 324, 326, 328, bottom 320, exterior surface 214, corners 317, and perimeter 321. An LCD panel 360 having a top surface 262 is positioned within reflective tray 301 adjacent the perimeter 321. First electrical connection 334 communicates with a light source (not shown) interior to the reflective tray 301 and extends outside the reflective tray 301, as described elsewhere. Second electrical connection 365 communicates with the LCD panel 360 interior to the reflective tray 301 and extends outside the reflective tray 301.

FIG. 4A shows a perspective schematic view of a foldable template 400 that can be used to form a reflective tray, according to one aspect of the disclosure. Foldable template 400 is made from a reflective sheet 410 that includes a first major surface 412, an opposing second major surface 414, and a perimeter 421. Exterior portions 418 are removed from the corners of the reflective sheet 410 to form edges 415, and optional openings 419 are cut through the thickness dimension of the reflective sheet. The exterior portions 418 and optional openings 419 can be removed using any suitable technique including, for example, knife cutting, die cutting, punching, laser cutting, and the like. A first score line 416 that is generally parallel to and separated from the perimeter 421 partially penetrates the thickness dimension of the reflective sheet 410, such that the reflective sheet 410 can be easily folded to form a tray having sides and a bottom, as described elsewhere.

A second score line 413 that is generally parallel to and separated from both the perimeter 421 and first score line 416, partially penetrates the thickness dimension of the reflective sheet 410, such that the reflective sheet 410 can be easily folded to form a tray having sides, a bottom, and a rim, as described elsewhere.

In one particular embodiment, the second score line 413 and the first score line 416 can both be disposed on the same major surface such as the first major surface 412, and the subsequent folds can form a “C” shape when viewed along the score lines, as shown in FIG. 4B. In this embodiment, the rim is disposed “within the tray” over the bottom, as described elsewhere. In some cases, the second score line 413 and the first score line 416 can be disposed on opposing major surfaces such as the first score line 416 can be on the first major surface 412 and the second score line 413 can be on the second major surface 414. In this case, the subsequent folds can form a “Z” shape when viewed along the score lines, and the rim is disposed “outside of the tray” (not shown in FIG. 4B). It is to be understood that the placement of each of the first and second score lines 413, 416, can be on whichever major surface is necessary to form the desired tray shape, and in some cases, the rim can be inside the tray or outside the tray on any desired number of sides.

The first and second score line 416, 413, can be made using any suitable technique including, for example, thermal or mechanical embossing, die cutting, kiss cutting, laser scoring, and the like. Laser scoring can be a preferred method of forming first and second score line 416, 413, as described elsewhere.

FIG. 4B shows a perspective schematic view of a reflective tray 401 formed from the foldable template 400 of FIG. 4A, according to one aspect of the disclosure. Reflective tray 401 is formed by folding up each of the portions between the first score line 416, the second score line 413, and perimeter 421 so that each of the edges 415 meet to form a corner 417. Reflective tray 401 includes a bottom 420, a first through fourth sides 422, 424, 426, and 428, an open top 429, a first through fourth rim 423, 425, 427, 239 extending over a portion of the open top surface 429 (i.e., “within the tray”), and interior surface 412 and exterior surface 414. It is to be understood from the discussion with reference to FIG. 4A, that depending on which major surface of the reflective sheet 410 the first and second score lines 416, 413 are disposed, the first through fourth rim 423, 425, 427, 239 can extend either “within the tray” as shown in FIG. 4B, “outside of the tray” (not shown), or a combination of “within the tray” and “outside of the tray”. Optional openings 419 are positioned in any or all of the bottom 420, sides 422, 424, 426, 428, and rims 423, 425, 427, 439, as desired, for attachment of components within the reflective tray 401 or for through-passage of electrical lines and the like, as described elsewhere. It is to be understood that reflective tray 401 can be substituted for any of the reflective trays 201 shown in FIGS. 2A-2H, and one of skill in the art would realize that any of the reflective trays 201 can also include one or more rims extending either “within the tray” or “outside the tray”.

In one particular embodiment, corners 417 may include an adhesive layer (not shown) or an adhesive tape (not shown) to bond the respective sides together. In some cases, corners 417 may be bonded together by other techniques including thermal bolding, ultrasonic welding, laser welding, or mechanical methods including slot/tab techniques and the like, as known to one of skill in the art. In some cases, reflective tray 401 can instead be thermoformed from reflective sheet 410, such as a Vikuiti™ ESR film, and the score lines 413, 416 may be optional. In some cases, the corners 417 in a thermoformed reflective tray 401 may be part of a contiguous film; however, the rims 423, 425, 427, 239 may still include a portion of the corner 417 that is not contiguous. In some cases, the thermoformed reflective tray 401 can be subsequently removed from the remaining reflective sheet 410 after forming by, for example, laser cutting, knife cutting, or die cutting. In some cases, reflective tray 401 can instead be thermoformed from reflective sheet 410 after the exterior portions 418 have been removed, and the corners 417 bonded together as described above. Thermoforming of polymeric films such as ESR films are known to those of skill in the art.

A variety of layers can be applied to any desired portion of the interior surface 412 and/or the exterior surface 414, as desired. These layers are optional, and can include coatings, films, and sheets that are deposited, adhered, laminated, or otherwise affixed to the respective surface. In one particular embodiment, the layer applied to the exterior surface 414 can be, for example, a thermally conductive layer, an optically absorptive layer, a combination thereof, and the like. In some cases, a thermally conductive exterior layer having, for example, thermally conductive particles in a binder, or metallic films or sheets, can be useful for aiding extraction of heat from a light source (not shown) that is placed within the reflective tray 401, as described elsewhere. In one particular embodiment, the layer applied to the interior surface 412 can be a diffuse layer, an optically absorptive layer, or a combination thereof. In some cases, a diffuse layer can be preferably applied to the interior surface 412 of one or more of the sides 422, 424, 426, 428, one or more of the rims 423, 425, 427, 439, or the bottom 420, of the reflective tray 401.

Following are a list of embodiments of the present disclosure.

Item 1 is an article, comprising: a reflective tray having sides, a bottom, and an open top, the reflective tray configured to at least partially enclose: a light guide; a light source optically coupled to the light guide; and at least one light management film immediately adjacent the open top, wherein the reflective tray comprises a polymeric dielectric multilayer reflector.

Item 2 is the article of item 1, wherein the reflective tray consists essentially of a polymeric dielectric multilayer reflector.

Item 3 is the article of item 1 or item 2, wherein the reflective tray is configured to at least partially enclose a liquid crystal display (LCD) disposed adjacent the open top, such that light from the light source that passes through the at least one light management film, enters the LCD.

Item 4 is the article of item 1 to item 3, wherein the reflective tray is a rectangular reflective tray having up to four sides.

Item 5 is the article of item 1 to item 4, wherein the polymeric dielectric multilayer reflector is an enhanced specular reflector (ESR).

Item 6 is the article of item 1 to item 5, wherein an exterior surface of the reflective tray includes a functional layer disposed thereon.

Item 7 is the article of item 6, wherein the functional layer is a thermally conductive layer, an optically absorptive layer, a structural layer, or a combination thereof.

Item 8 is the article of item 6, wherein the functional layer comprises thermally conductive particles in a binder or a metal.

Item 9 is the article of item 1 to item 8, wherein at least one of the sides and the bottom include a diffuse reflective layer applied to an interior surface thereon.

Item 10 is the article of item 1 to item 9, wherein at least one of the sides and the bottom include at least one opening.

Item 11 is the article of item 10, wherein the at least one opening is configured to accommodate an electrical connection, a light guide support, a light source support, a light management film support, passage of light from an external light source, or a combination thereof.

Item 12 is the article of item 1 to item 11, wherein the at least one light management film comprises a reflective polarizer film, a diffuser film, a microstructured brightness enhancing film, or a combination thereof.

Item 13 is the article of item 1 to item 12, wherein the reflective tray is a thermoformed ESR film.

Item 14 is the article of item 1 to item 13, wherein the reflective tray is a folded ESR film.

Item 15 is the article of item 1 to item 14, wherein the at least one light management film is a folded film having a first surface parallel to the bottom and a second surface parallel to at least one side.

Item 16 is the article of item 1 to item 15, wherein the reflective tray further comprises a rim parallel to the bottom and extending from the sides either over a portion of the open top, or exterior to the open top, or a combination thereof, the rim comprising the polymeric dielectric multilayer reflector.

Item 17 is the article of item 16, wherein the rim consists essentially of the polymeric dielectric multilayer reflector.

Item 18 is an article, comprising: a reflective tray having sides, a bottom, and an open top; a light guide and a light source optically coupled to the light guide, disposed between the bottom and the open top; and at least one light management film immediately adjacent the open top, wherein the reflective tray comprises a polymeric dielectric multilayer reflector.

Item 19 is the article of item 18, wherein the reflective tray consists essentially of a polymeric dielectric multilayer reflector.

Item 20 is the article of item 19, wherein the polymeric dielectric multilayer reflector is an enhanced specular reflector (ESR).

Item 21 is the article of item 18 to item 20, further comprising a liquid crystal display (LCD) disposed adjacent the open top, such that light from the light source that passes through the at least one light management film, enters the LCD.

Item 22 is the article of item 21, further comprising a frame extending around a perimeter of the LCD, wherein the sides of the reflective tray are interior to the frame or exterior to the frame.

Item 23 is a method, comprising: scoring a polymeric dielectric multilayer reflector along a bottom perimeter of a reflective tray bottom, the reflective tray bottom having corners; removing portions of the polymeric dielectric multilayer reflector exterior to the reflective tray bottom and adjacent the corners; and folding the polymeric dielectric multilayer reflector along the bottom perimeter to form a reflective tray having sides extending perpendicular to the reflective tray bottom, and an open top.

Item 24 is the method of item 23, wherein the reflective tray bottom has a rectangular shape and four corners, and the portions of the polymeric dielectric multilayer reflector removed include a 90 degree angle adjacent each of the four corners.

Item 25 is the method of item 23 or item 24, further comprising scoring the polymeric dielectric multilayer reflector at a side height exterior to the bottom perimeter, and folding the polymeric dielectric multilayer reflector along the side height score to form a rim parallel to the reflective tray bottom and extending from the sides either over a portion of the reflective tray bottom, exterior to the open top, or a combination thereof.

Item 26 is the method of item 25, wherein scoring comprises laser scoring, thermal scoring, mechanical scoring, or a combination thereof.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. An article, comprising:
a reflective tray having sides, a bottom, and an open top, the reflective tray configured to at least partially enclose:
a light guide;
a light source optically coupled to the light guide; and
at least one light management film immediately adjacent the open top,
wherein the reflective tray comprises a polymeric dielectric multilayer reflector.

2. The article of claim 1, wherein the reflective tray consists essentially of a polymeric dielectric multilayer reflector.

3. The article of claim 1, wherein the reflective tray is configured to at least partially enclose a liquid crystal display (LCD) disposed adjacent the open top, such that light from the light source that passes through the at least one light management film, enters the LCD.

4. The article of claim 1, wherein the reflective tray is a rectangular reflective tray having up to four sides.

5. The article of claim 1, wherein the polymeric dielectric multilayer reflector is an enhanced specular reflector (ESR).

6. The article of claim 1, wherein an exterior surface of the reflective tray includes a functional layer disposed thereon.

7. The article of claim 6, wherein the functional layer is a thermally conductive layer, an optically absorptive layer, a structural layer, or a combination thereof.

8. The article of claim 6, wherein the functional layer comprises thermally conductive particles in a binder or a metal.

9. The article of claim 1, wherein at least one of the sides and the bottom include a diffuse reflective layer applied to an interior surface thereon.

10. The article of claim 1, wherein at least one of the sides and the bottom include at least one opening.

11. The article of claim 10, wherein the at least one opening is configured to accommodate an electrical connection, a light guide support, a light source support, a light management film support, passage of light from an external light source, or a combination thereof.

12. The article of claim 1, wherein the at least one light management film comprises a reflective polarizer film, a diffuser film, a microstructured brightness enhancing film, or a combination thereof.

13. The article of claim 1, wherein the reflective tray is a thermoformed ESR film.

14. The article of claim 1, wherein the reflective tray is a folded ESR film.

15. The article of claim 1, wherein the at least one light management film is a folded film having a first surface parallel to the bottom and a second surface parallel to at least one side.

16. The article of claim 1, wherein the reflective tray further comprises a rim parallel to the bottom and extending from the sides either over a portion of the open top, or exterior to the open top, or a combination thereof, the rim comprising the polymeric dielectric multilayer reflector.

17. The article of claim 16, wherein the rim consists essentially of the polymeric dielectric multilayer reflector.

18. An article, comprising:
a reflective tray having sides, a bottom, and an open top;
a light guide and a light source optically coupled to the light guide, disposed between the bottom and the open top; and
at least one light management film immediately adjacent the open top,
wherein the reflective tray comprises a polymeric dielectric multilayer reflector.

19. The article of claim 18, wherein the reflective tray consists essentially of a polymeric dielectric multilayer reflector.

20. The article of claim 18, wherein the polymeric dielectric multilayer reflector is an enhanced specular reflector (ESR).

21. The article of claim 18, further comprising a liquid crystal display (LCD) disposed adjacent the open top, such that light from the light source that passes through the at least one light management film, enters the LCD.

22. The article of claim 21, further comprising a frame extending around a perimeter of the LCD, wherein the sides of the reflective tray are interior to the frame or exterior to the frame.

23. A method, comprising:
scoring a polymeric dielectric multilayer reflector along a bottom perimeter of a reflective tray bottom, the reflective tray bottom having corners;
removing portions of the polymeric dielectric multilayer reflector exterior to the reflective tray bottom and adjacent the corners; and
folding the polymeric dielectric multilayer reflector along the bottom perimeter to form a reflective tray having sides extending perpendicular to the reflective tray bottom, and an open top.

24. The method of claim 23, wherein the reflective tray bottom has a rectangular shape and four corners, and the portions of the polymeric dielectric multilayer reflector removed include a 90 degree angle adjacent each of the four corners.

25. The method of claim 23, further comprising scoring the polymeric dielectric multilayer reflector at a side height exterior to the bottom perimeter, and folding the polymeric dielectric multilayer reflector along the side height score to form a rim parallel to the reflective tray bottom and extending from the sides either over a portion of the reflective tray bottom, exterior to the open top, or a combination thereof.

26. The method of claim 23, wherein scoring comprises laser scoring, thermal scoring, mechanical scoring, or a combination thereof.
